(19) United States
(12) Patent Application Publication
(10) Pub. No.: US 2014/0115711 A1
(43) Pub. Date: Apr. 24, 2014

(54) Method and apparatus for delivering private media content to smart phones

(71) Applicants: Jerry Stevenson, Coppell, TX (US); James Cross, Allen, TX (US)

(72) Inventors: Jerry Stevenson, Coppell, TX (US); James Cross, Allen, TX (US)

(21) Appl. No.: 13/655,755

(22) Filed: Oct. 19, 2012

(51) Int. Cl. H04L 29/06

(52) U.S. Cl. CPC H04L 63/04
USPC 726/26

(57) ABSTRACT

A device to receive media content may include a smart phone; a camera to cooperate with the smart phone to transmit a quick response (QR) code to the smart phone; a database to cooperate with the smart phone to verify the QR code; a media storage device to cooperate with the smart phone to stream media data if the QR code is verified.

### FIELD OF THE INVENTION

The present invention relates to delivering private media content and more particularly to delivering private media content to a mobile communication device or platform with selected media content by streaming networks.

### BACKGROUND

It is desirable to send and receive streaming selected media content from a wireless source. However, it is desirable to assure that the recipients of the selected media content are the intended recipients. More particularly, it is desirable to assure that the recipients are authorized or otherwise paid for the selected media content. Additionally, it is desirable to block or inactivate users who are not authorized to receive the streaming media content.

U.S. Pat. No. 8,210,430 discloses a shelf code in a machine readable format, such as on a QR code on a printed card, being provided where bulk merchandise displayed in a bin. When the bin is stocked from a case bearing a case code, the case code is associated with the shelf code. Lot-specific and lot-independent information previously associated with the case code is then linked to the shelf code. Consumers scan the shelf code with a mobile device to establish a communication channel to access the linked information. Retailers and producers use the channel to reach the consumer, and to solicit feedback from the consumer at a known time and location. A mobile device can also be used to associate quality assessments of merchandise to the shelf code. Analysis of consumer ratings and quality inspection assessments that are tied to time and location can provide valuable insights to both producers and retailers.

U.S. Pat. No. 7,273,175 discloses a method, an apparatus and a storage medium for locating QR codes. For automatically locating a plurality of QR codes in image of any size, the invention provides an apparatus for locating at least one QR code in an image, comprising: characteristic ratio detection means for detecting the potential QR code location symbol areas by carrying out a plurality of detections for detecting the characteristic ratio of the QR code; critical edge detection means for detecting the critical edges of the potential QR code location symbol areas so that the false areas are excluded; location symbol grouping means for matching the detected QR code location symbol areas into potential QR codes; and verification means for excluding the false QR codes. The invention also provides a corresponding method for locating at least one QR code.

US patent application 20120138671 discloses a party that is not the source or originator of a QR code being enabled to provide a consumer a selection of related alternate content rather than content identified in the QR code. A method is implemented on a computer system to receive additional content information represented by a QR code extracted by a consumer's QR reader device from a media presentation containing the QR code. The QR code is generated by a source of the media presentation. A location of alternate content from a captive environment related to the additional content information is identified. The location of the alternate content may be identified based upon the decoded information from the QR code. The location of the alternate content is transmitted to the QR reader device.

US patent application 20120128267 discloses an electronic device which may derive information specific to the device, dynamically generate a matrix code that includes the information as well as user support information, and transmit the dynamically generated code to a display. When a user captures the matrix code with a reader device, the reader device may decode (or use a back end server to decode) the specific information specific and the user support information and initiate a user support request. Thus, user support for electronic devices may be facilitated utilizing dynamically generated matrix codes, such as (but not limited to) QR codes. In response to the initiated user support request, user support may then be provided for the user. Problems may be automatically taken care of for the user, tutorials may be provided for the user, one or more notifications may be provided to the user, service calls may be scheduled for the user, and so on.

US patent application 20120084179 discloses an electronic device which may derive information specific to the device, dynamically generate a matrix code that includes the information as well as user support information, and transmit the dynamically generated code to a display. When a user captures the matrix code with a reader device, the reader device may decode (or use a back end server to decode) the specific information specific and the user support information and initiate a user support request. Thus, user support for electronic devices may be facilitated utilizing dynamically generated matrix codes, such as (but not limited to) QR codes. In response to the initiated user support request, user support may then be provided for the user. Problems may be automatically taken care of for the user, tutorials may be provided for the user, one or more notifications may be provided to the user, service calls may be scheduled for the user, and so on.

US patent application 20110137742 discloses various methods and systems being provided to capture a unique product code, such as QR code, on a mobile device, process the information contained in the code, provide the user with options of making a purchase, including purchasing a plurality of selected products from different captured codes, and processing the payment via the user's mobile device.

Conventionally, a talk photo production system has been proposed which prints voice data on a photo print as a bar code, and reads this bar code by means of a bar code reader to convert the bar code into voice to be pronounced (Japanese Patent Application Publication No. 2001-51368).

In addition, a mobile communication terminal (camera-equipped cellular phone) has been proposed which can shoot a two-dimensional code (for example, a QR code) printed on an advertising medium such as a poster, a wall banner, a community magazine or the like and decrypt the two-dimensional code to acquire information (Japanese Patent Application Publication No. 2002-118680).

The above described two-dimensional code includes a URL (Uniform Resource Locators) of a site, in which detailed information on products or services to be advertised is posted, and the above described camera-equipped cellular phone may access the above described site by means of the URL included in the two-dimensional code.

Accordingly, a user can access easily the site related to a desired advertising medium.

These references are incorporated by reference in the entirety.

### SUMMARY

A device to receive media content may include a smart phone; a camera to cooperate with the smart phone to transmit a quick response (QR) code to the smart phone; a database to cooperate with the smart phone to verify the QR code; a media storage device to cooperate with the smart phone to stream media data if the QR code is verified.

The smart phone may include a controller.

The database may include a controller.

The media storage may include a controller.

The QR code may be printed on a sheet.

The QR code may be printed on an envelope.

The QR code may be printed on a business card.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a smart phone of the present invention;

FIG. 2 illustrates a circuit diagram of the smart phone of the present invention;

FIG. 3 illustrates a circuit diagram of the smart phone database of the present invention;

FIG. 4 illustrates a circuit diagram of the media story circuit of the present invention;

FIG. 5 illustrates a system diagram of the present invention:

FIG. 6 illustrates a QR code on a sheet for the present invention.

### DETAILED DESCRIPTION

A preferred embodiment of a service server and a service method for delivering streaming media which may include audio, video, a combination of audio and video or other types of streaming information according to the present invention will be described below in detail with reference to the accompanying drawings.

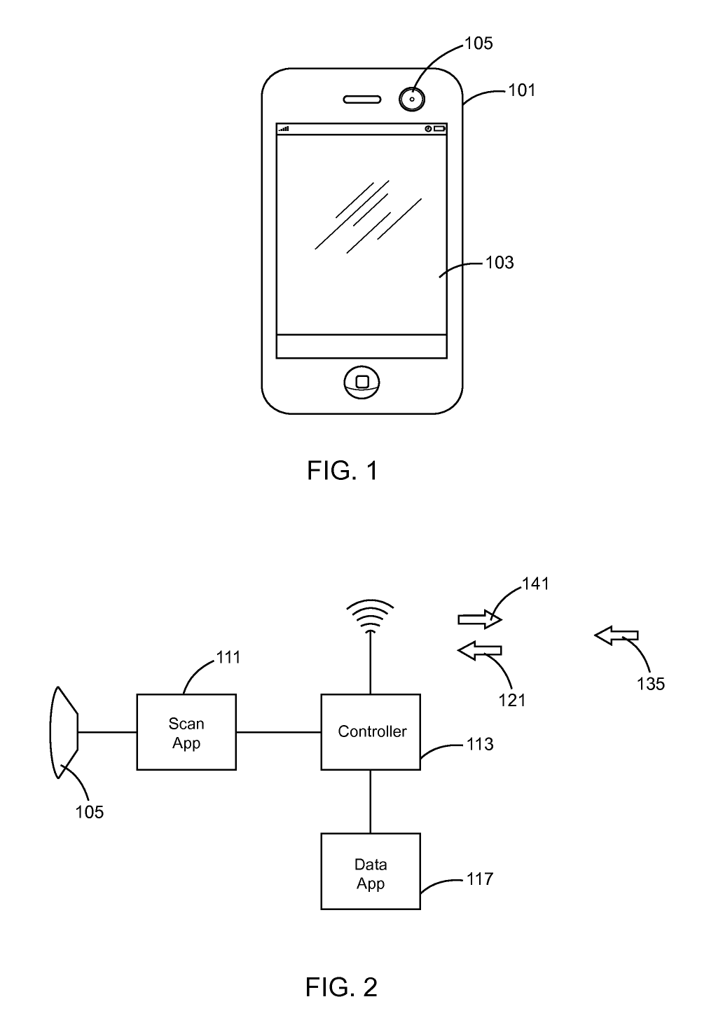

FIG. 1 illustrates a smart phone 101 of the present invention which may include a display 103 which may display images and may include a touchstone screen to control the smart phone 101 and may include a camera 105 in order to obtain images and which may be an electronic device, a portable device, a wireless device, a tablet, a notebook, a personal computer (PC), iPod, iPad, iTouch, cell phone, camera phone or other such devices. The present invention includes an identification system which may include a QR code which may be printed on business cards or other printed items and which may include a similar device as the source. The camera 105 may be used to obtain an image from a printed sheet 107 (shown in FIG. 6) which may

include a QR code 109 (shown in FIG. 6) printed on the printed sheet 107. The camera 105 may transmit the image of the printed sheet 107 which may include the QR code 109 to a scan application 111 which may transmit the image of the printed sheet 107 including the QR code 109 to a smart phone controller 113 which may transmit the image of the printed sheet 107 including the QR code 109 to a database controller 115 for verification of the QR code 109 to activate a data application which may receive streaming data 121 from the database controller 115.

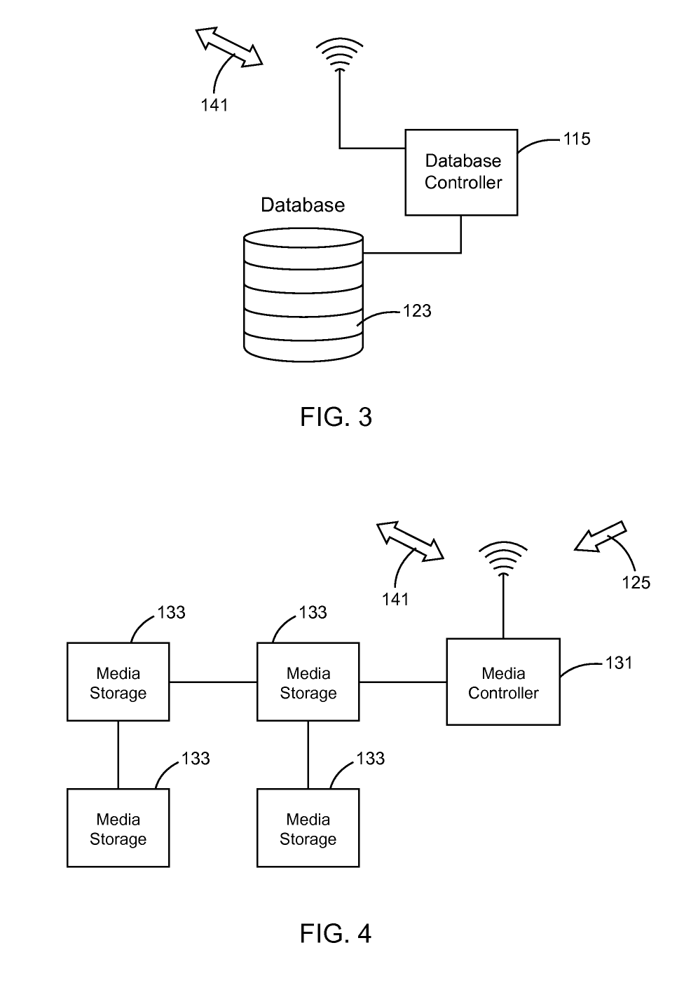

FIG. 3 illustrates the database controller 115 which may transmit and receive signals from the smart phone controller 113. The database controller 115 may receive the image of the print sheet 107 which may include the QR code 109 and may interrogate the QR code 109 by accessing the database 123 which may or may not be required to compare the QR code 109 transmitted by the smart phone controller 113 and received by the database controller 115 with known QR codes which may have been previously stored within the database controller 115.

If the database controller 115 validates the QR code 109, the database controller 115 transmits a activation signal 125 to the media controller 131 shown in FIG. 4, and when the media controller 131 receives the activation signal 125, the media controller 131 retrieves the media content from the media storage 133 and transmits the media content from the media storage 113 to the smart phone controller 113 which transmits the media content to the data application 117 which may display the media content on the display 103. If the database controller 115 does not validate the QR code 109 the de-activation signal 135 is transmitted to the smart phone controller 113 which deactivates the data application 117.

The smart phone controller 113 may be connected to the database controller 115 which may be connected to the media controller 113 wirelessly or through the Internet 141. Each of the controllers 113, 115, 131 may be a microcontroller electronic circuit. The database may be a storage circuit.

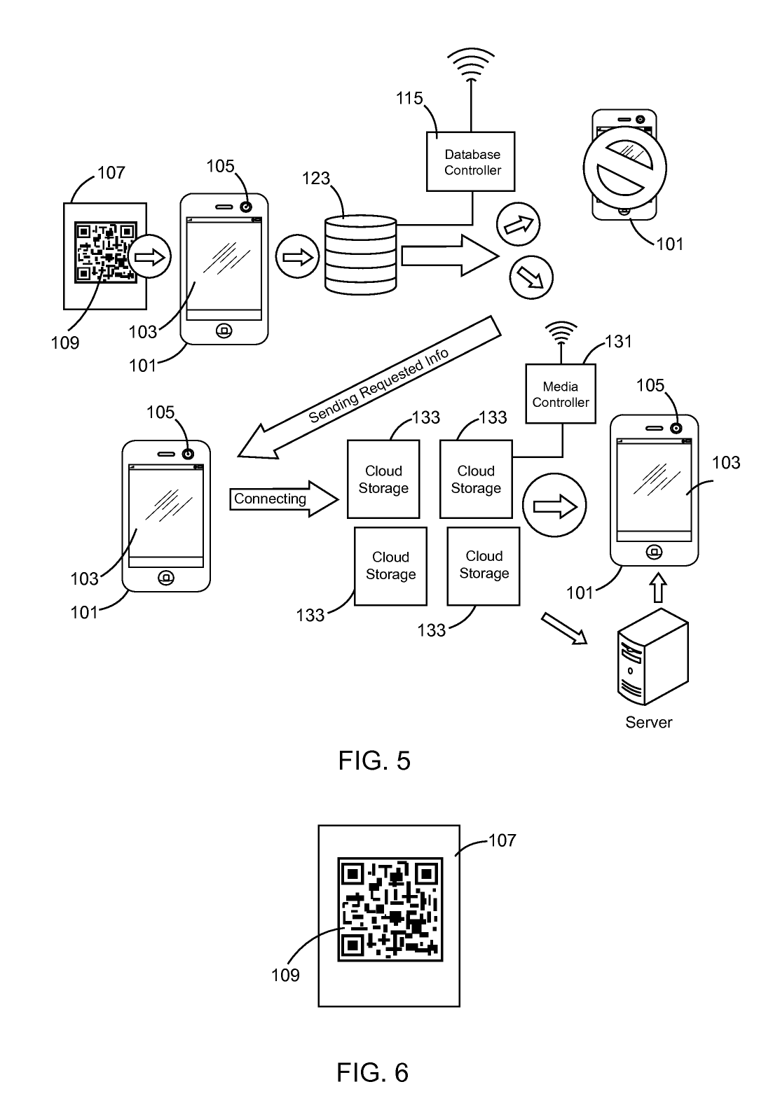

FIGS. 1-6 illustrate a smart phone 101 of the present invention which may include a display 103 which may display images and may include a touchstone screen to control the smart phone 101 and may include a camera 105 in order to obtain images. The present invention includes an identification system which may include a QR code which may be printed on business cards or other printed items. The camera 105 may be used to obtain an image from a printed sheet 107 (shown in FIG. 6) which may include a QR code 109 (shown in FIG. 6) printed on the printed sheet 107. The camera 105 may transmit the image of the printed sheet 107 which may include the QR code 109 to a scan application 111 which may transmit the image of the printed sheet 107 including the QR code 109 to a smart phone controller 113 which may transmit the image of the printed sheet 107 including the QR code 109 to a database controller 115 (see Figure for verification of the QR code 109 to activate a data application which may receive streaming data 121 from the database controller 115.

FIG. 3 illustrates the database controller 115 which may transmit and receive signals from the smart phone controller 113. The database controller 115 may receive the image of the print sheet 107 which may include the QR code 109 and may interrogate the QR code 109 by accessing the database 123 to compare the QR code 109 transmitted by the smart phone controller 113 and received by the database controller 115 with known QR codes which may have been previously stored within the database controller 115.

If the database controller 115 validates the QR code 109, the database controller 115 transmits a activation signal 125 to the media controller 131 shown in FIG. 4, and when the media controller 131 receives the activation signal 125, the media controller 131 retrieves the media content from the media storage 133 and transmits the media content from the media storage 113 to the smart phone controller 113 which transmits the media content to the data application 117 which may display the media content on the display 103. If the database controller 115 does not validate the QR code 109 the de-activation signal 135 is transmitted to the smart phone controller 113 which deactivates the data application 117.

The smart phone controller 113 may be connected to the database controller 115 which may be connected to the media controller 113 wirelessly or through the Internet 141. Each of the controllers 113, 115, 131 may be a microcontroller electronic circuit. The database may be a storage circuit. The printed sheet 107 may be an envelope, a business card, clothing or other such device.

In operation, the QR code or quick response code is printed on a document or clothing or any kind of printable material. A proprietary application or app is used by an onboard camera of the smart phone to scan and decode via internal decoder in order to access the database. The database then verifies the identity of the application requesting the information which may be streaming media data from the records in the database based upon the QR code. If the app is approved by the database, then the app is routed to the cloud storage or media storage to retrieve the media content. The media content is then directed to the application or up and the media content is screen by a streaming server.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A device to receive media content, comprising:
a smart phone;
a camera to cooperate with the smart phone to transmit a quick response (QR) code to the smart phone;
a database to cooperate with the smart phone to verify the QR code;
a media storage device to cooperate with the smart phone to stream media data if the QR code is verified.

2) A device to receive media content as in claim 1, wherein the smart phone includes a controller.

3) A device to receive media content as in claim 1, wherein the database includes a controller.

4) A device to receive media content as in claim 1, wherein the media storage includes a controller.

5) A device to receive media content as in claim 1, wherein the QR code is printed on a sheet.

6) A device to receive media content as in claim 1, wherein the QR code is printed on an envelope.

7) A device to receive media content as in claim 1, when the QR code is printed on a business card.

8) A device to receive media content as in claim 1, wherein the smart phone is a electronic device.

9) A device to receive media content as in claim 1, wherein the smart phone is a portable device.

10) A device to receive media content as in claim 1, wherein the smart phone is a wireless device.

11) A device to receive media content as in claim 1, wherein the smart phone is a tablet.

12) A device to receive media content as in claim 1, wherein the smart phone is a notebook.

13) A device to receive media content as in claim 1, wherein the smart phone is a personal computer.

14) A device to receive media content as in claim 1, wherein the smart phone is an iPod.

15) A device to receive media content as in claim 1, wherein the smart phone is an iPad.

16) A device to receive media content as in claim 1, wherein the smart phone is a cell phone.

17) A device to receive media content as in claim 1, wherein the smart phone is a iTouch.

18) A device to receive media content as in claim 1, wherein the smart phone is a camera phone.
